(19) United States
(12) Patent Application Publication
(10) Pub. No.: US 2013/0023686 A1
(43) Pub. Date: Jan. 24, 2013

(54) ORGANIC-INORGANIC HYBRID PREPOLYMER AND PROCESS FOR PRODUCTION THEREOF

(71) Applicants: Takuya Shindou, Amagasaki-shi (JP); Hidenori Kubo, Amagasaki-shi (JP); Midorii Satoh, Amagasaki-shi (JP)

(72) Inventors: Takuya Shindou, Amagasaki-shi (JP); Hidenori Kubo, Amagasaki-shi (JP); Midorii Satoh, Amagasaki-shi (JP)

(73) Assignee: NIHON YAMAMURA GLASS CO., LTD., Hyogo (JP)

(21) Appl. No.: 13/638,192

(22) PCT Filed: Mar. 31, 2011
(86) PCT No.: PCT/JP2011/058202

§ 371 Date: Sep. 28, 2012

(30) Foreign Application Priority Data
Mar. 31, 2010 (JP) 2010-084574

(51) Int. Cl. C07F 7/02

(52) U.S. Cl. 556/451

(57) ABSTRACT

The object of the present invention is to provide an organic-inorganic hybrid prepolymer, or an organic-inorganic hybrid polymer which is prepared by gelling the prepolymer, wherein the prepolymer or polymer contains no clusters of inorganic components, and the object is attained by providing an organic-inorganic prepolymer which is prepared by introducing a metal and/or semimetal alkoxide oligomer to one or both ends of a polydimethylsiloxane having silanol group(s) on one or both ends by condensation reaction accompanied with hydrolysis.

### FIELD OF THE INVENTION

The present invention relates an organic-inorganic hybrid prepolymer which can be used as a heat resistant elastic material, etc. and further a method for the preparation thereof.

### BACKGROUND OF THE INVENTION

Hitherto, a heat resistant material has been used as a film, tape, sealant, or the like, to be used in electronic parts, electric parts or the like, for said parts insulation or fixation, said film, tape, sealant or the like being required to have heat resistance. A typical heat resistant material is a silicone resin. Said silicone resin is a well-known elastic material having both heat resistance, and high safety, and furthermore, being low-priced. Recently, an organic-inorganic hybrid composite having improved properties of said silicone resin has been developed. Said organic-inorganic hybrid is prepared by introducing an inorganic component to said silicone resin.

Said organic-inorganic hybrid composite has both the properties of silicone resin as an organic component, such as flexibility, water-repellency, release properties or the like, and the properties of an inorganic component, such as heat resistance, heat conductivity or the like (for instance, see Patent Document 1). Said material has excellent properties such as heat resistance at high temperatures of higher than 200° C., flexibility, and further, high electric insulation strength, and low dielectricity at a high frequency range.

### PRIOR TECHNICAL DOCUMENTS

### Patent Documents

Patent Document 1: JPH01-113429
Patent Document 2: JPH02-182728
Patent Document 3: JPH04-227731
Patent Document 4: JP2009-292970
Patent Document 5: JP2004-128468
Patent Document 6: JP2009-024041
Patent Document 7: JPH06-237559
Patent Document 8: JPH05-263062
Patent Document 9: JP2002-277185
Patent Document 10: JP2004-107652
Patent Document 11: JP2005-320461

### NON-PATENT DOCUMENT

Non-Patent Document: G. Philipp and Schmidt, J. Non-Cryst. Solids 63,283 (1984)

### SUMMARY OF THE INVENTION

### Problems to be Solved by the Invention

Conventionally, an organic-inorganic hybrid composite is prepared by adding a metal and/or semimetal alkoxide to a solution of a polydimethylsiloxane having silanol group(s) on one or both ends, preparing a low molecular organic-inorganic hybrid prepolymer sol by a condensation reaction between said polydimethylsiloxane with hydrolysis and said metal and/or semimetal alkoxide, and heating the resulting sol to gelatinize by a polycondensation reaction.

During said condensation or polycondensation, said metal and/or semimetal alkoxide is hydrolyzed by the minute quantity of water present in the condensation reaction system, and the resulting hydrolyzed metal and/or semimetal alkoxide singly polycondenses prior to the condensation reaction between said polydimethylsiloxane and said metal and/or semimetal alkoxide, producing a low molecular metal and/or semimetal alkoxide polycondensate. The resulting low molecular metal and/or semimetal alkoxide polycondensate condenses in said reaction system, resulting in the production of solid minute particles called clusters in said organic-inorganic prepolymer sol.

Alternatively, even in a case where said clusters are not produced in said organic-inorganic hybrid prepolymer, if said metal and/or semimetal alkoxide remains in said sol, and said metal and/or semimetal alkoxide causes the gelation of said prepolymer sol to produce the organic-inorganic hybrid composite, during said gelation of said prepolymer, said metal and semimetal alkoxide singly polycondenses to produce clusters in said organic-inorganic hybrid prepolymer, and as a result, the organic-inorganic hybrid composite in which said clusters are mixed is produced.

As aforementioned, in a case where the prepolymer sol in which clusters are mixed, or the organic-inorganic hybrid composite in which clusters are produced and mixed during the gelation of said prepolymer by heating, are used, for example, in a heat conductive sheet or an adhesive sheet, the mechanical strength and gas barrier properties of the resulting sheet may deteriorate, and in a case where the prepolymer sol in which said clusters are mixed, or an organic-inorganic hybrid composite in which said clusters are produced and mixed during the gelation of said prepolymer by heating, are used as the sealant of a semiconductor element such as the luminescence element of a laser diode, the light receiving element of an image sensor, or the like, said clusters will cause a little blurring (distortion) when light penetrates through said element, resulting in the optical properties of said element being deteriorated (Patent Documents 5 and 6).

To prevent the production of said clusters, conventionally the silanol group(s) of the end(s) of polydimethylsiloxane is (are) modified with alcohol so as to change it (them) to alkoxyl group(s) and increase the reactivity between said polydimethylsiloxane and said metal and/or semimetal alkoxide (Patent Document 4).

Nevertheless, since the denaturing process of said polydimethylsiloxane is further added to the production process of said organic-inorganic hybrid compound, there is a problem in that the production of said organic-inorganic hybrid compound requires a troublesome process. Still further, the reaction time should be prolonged, and the reaction temperatures should be raised, so as to improve the efficiency of the denaturing of said polydimethylsiloxane, but in this case, the cutting of the chain or polymerization of said polydimethylsiloxane may arise, resulting in a change in the polymerization degree of said polydimethylsiloxane, and/or a rise in the viscosity of the resulting prepolymer sol solution, thus its workability for coating or the like may be deteriorated.

Accordingly, the degree of denaturing of said polydimethylsiloxane should be kept in the range of between about 20 and 50%, but the degree of denaturing within such a low range can not sufficiently improve the reactivity of said polydimethylsiloxane, and can not completely prevent the production of said clusters in said sol (Patent Documents 7 to 11).

### Means to Solve Said Problems

As a means to solve the aforementioned problems, the present invention provides an organic-inorganic hybrid prepolymer which is prepared by introducing a metal and/or semimetal alkoxide oligomer to one or both ends of a polydimethylsiloxane having silanol group(s) on one or both ends by a condensation reaction accompanied with hydrolysis.

It is desirable that said polydimethylsiloxane having silanol group(s) on one or both ends has a weight-average molecular weight in the range of between 1,500 and 100,000, and that said metal and/or semimetal alkoxide oligomer has a degree of polymerization in the range of between 4 and 16, and further that said metal and/or semimetal alkoxide is a silane alkoxide.

Further, the present invention provides a method for preparing an organic-inorganic hybrid prepolymer by substituting an inert gas atmosphere in a reactor, filling said reactor with a solution of a polydimethylsiloxane having silanol group(s) on one or both ends, adding a metal and/or semimetal alkoxide to said solution in said reactor, and performing a hydrolysis and condensation reaction, so as to introduce said metal and/or semimetal alkoxide to one or both ends of said polydimethylsiloxane.

It is desirable that said polydimethylsiloxane having silanol group(s) on one or both ends has a weight-average molecular weight in the range of between 3000 and 100,000, and that said metal and/or semimetal oligomer has a degree of polymerization in the range of between 4 and 16, and further that said metal and/or semimetal alkoxide is a silane alkoxide.

### Effect of the Invention

### Actions

In the present invention the metal and/or semimetal alkoxide oligomer is hydrolyzed, and the resulting hydrolysate and the polydimethylsiloxane having silanol group(s) on one or both ends are condensed together, so as to introduce said metal and/or semimetal alkoxide to one or both ends of said polydimethylsiloxane, producing an organic-inorganic hybrid prepolymer sol. Since said oligomer has a comparatively high molecular weight, said oligomer doesn't easily volatilize from the reaction system, and further, since said oligomer has a lower density functional group (alkoxy group) than the metal and/or semimetal alkoxide monomer, the tendency of a single polycondensation of said oligomer is minimized, so that said oligomer reacts nearly quantitatively with said polydimethylsiloxane.

[Effect]

Since no cluster as an inorganic component exists in said organic-inorganic hybrid prepolymer, or said organic-inorganic hybrid polymer which is a gelling prepolymer, an organic-inorganic hybrid material having a higher quality than the conventional organic-inorganic hybrid material can be provided in the present invention.

### EMBODIMENTS TO PRACTICE THE INVENTION

### Definition

### [Semimetal]

The elements around the boundary between metallic elements and non-metalic elements in the periodic table, such as boron, silicon, germanium, arsenic, antimony, selenium, tellurium, or the like.

### [Organic-Inorganic Hybrid Prepolymer]

A sol-like compound produced by condensing a metal and/or semimetal alkoxide oligomer (hereafter merely described as an “oligomer”) to the end silanol group(s) of polydimethylsiloxane (hereafter merely described as an abbreviation “PDMS”) having silanol group(s) on one or both ends.

### [Organic-Inorganic Hybrid Polymer]

A solid or semisolid polymer produced through the polycondensation-gelation of said organic-inorganic hybrid prepolymer by heating.

### [Weight Average Molecular Weight]

The weight average molecular weight of the PDMS was measured by the gel permeation chromatograph method (GPC method), polystyrene being used as a standard sample, and the conversion molecular weight by polystyrene being measured.

### [Cluster]

The polycondensate of the metal and/or semimetal alkoxide. Said polycondensate having a solid particle shape, and being produced during the production process of said organic-inorganic prepolymer or polycondensation-gelation process of said prepolymer.

### [Rate of Denaturing]

The rate of said oligomer introduced to silanol group(s) positioned at one or both ends of the PDMS by a condensation reaction. For instance, a denaturing rate of 50% means that said oligomers have been introduced to 50% of the silanol group of the PDMS.

[Metal and/or Semimetal Alkoxide]

Said metal and/or semimetal alkoxide has following general formula.

M(OR)₄ [Formula 1]

Wherein M is a metal or semimetal, R is an alkyl group having a carbon number of below 4, and said alkyl groups may be the same, partially different from each other, or all completely different.

As a metal and/or semimetal of said metal and/or semimetal alkoxide to be used in the present invention, silicone, boron, aluminum, titanium, vanadium, manganese, iron, cobalt, zinc, germanium, yttrium, zirconium, niobium, lanthanum, cerium, cadmium, tantalum, tungsten, or the like is (are) illustrated. A desirable metal or semi-metal may be silicone, titanium and zirconium.

Further, the kind of said alkoxide is not especially limited, and said alkoxide may include such as methoxide, ethoxide n-propoxide, iso-propoxide, n-butoxide, iso-butoxide, sec-butoxide, tert-butoxide, methoxy-ethoxide, ethoxy-ethoxide or the like, and from the view point of stability and safety, ethoxide, propoxide, isopropoxide, or the like are desirable alkoxides.

As said metal and/or semimetal alkoxide, silicone alkoxide is a particularly desirable alkoxide, since said silicone alkoxide is easily procured, and stable in the air.

Said silicone alkoxide may include tetraalkoxy silane such as tetramethoxy silane, tetraethoxy silane, tetrapropoxy silane, tetraisopropoxy silane, tetrabutoxy silane or the like, trialkoxy silane such as methyltrimethoxy silane, methyltriethoxy silane, methyl tripropoxy silane, methyl tributoxy silane, ethyl trimethoxy silane, ethyltriethoxy silan, n-propyl trimethoxy silane, n-propyl triethoxy silane, isopropyl trimethoxy silane isopropyl triethoxy silane, phenyl trimethoxy silane, phenyl triethoxy silane or the like. In said silicone alkoxides, tetraethoxy silane (TEOS), triethoxymethyl silane (TEOMS), tetra-propoxy silane, tetraisopropoxy silane, tetrabutoxy silane are desirable silicone alkoxides. Other desirable metal alkoxyde may be such as titanium tetraisopropoxide (TTP), zirconium teterapropoxide (ZTP) or the like.

### [Polydimethylsiloxane]

The polydimethylsiloxane used in the present invention is a polydimethylsiloxane having silanol group(s) which can react with said metal and/or semimetal alkoxide on one or both ends. Said polydimethylsiloxane is indicated in the following general formula.

(a) a PDMS having silanol groups on both ends

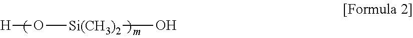

(b) a PDMS having a silanol group on one end.

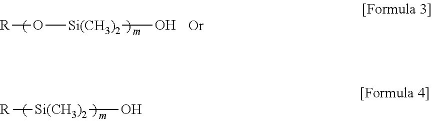

In said chemical formula, m is an integral number of 50 or more. The weight average molecular weight of said PDMS is desirably 1,500 or more, and 100,000 or less, in the present invention.

[Metal and/or Semimetal Alkoxide Oligomer]

Said metal and/or semimetal alkoxide oligomer used in the present invention (hereafter merely described as “oligomer”) is low condensate of said metal and/or semimetal alkoxide, and has the following general formula.

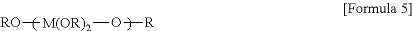

Wherein M is a metal or semimetal, R is an alkyl group having a carbon number of below 4, and said alkyl groups may be the same, partially different from each other, or all completely different, and n is an integral number between 4 and 6.

Since said oligomer has a lower volatility and lower density in its functional group (alkoxy group) than said metal and/or semimetal alkoxyde monomer, said oligomer has a lower reactivity than said metal and/or semimetal alkoxide monomer.

### [Preparation of Organic-Inorganic Hybrid Prepolymer Sol]

In the present invention said PDMS and said oligomer are condensed together so as to prepare an organic-inorganic hybrid prepolymer. In said condensation reaction, the hydrolysis of the alkoxy group at the end of said oligomer accompanies.

In said condensation reaction, commonly a condensation catalyst is used. Said condensation catalyst may include such as stannous octoate, dibutyltindilaurate, dibytyltindi-2-ethylhexoate, natrium-O-phenylphenate, tetra(2-ethylhexosil) titanate, or the like.

In a case where said condensation reaction between said PDMS and said oligomer is carried out in the present invention, in order to hydrolyze said oligomer stably, a hydrolysis and condensation reaction are carried out by heating in a reactor filled with an inert gas. By replacing the air with said inert gas in said reactor, unnecessary hydrolysis reaction of said oligomer by the moisture in the air is suppressed, so that the condensation reaction with the hydrolysis between said PDMS and said oligomer is promoted. Further, said condensation reaction is also promoted by supplying said inert gas at a constant rate into said reactor, so as to remove alcohol or water produced during said condensation reaction gradually from the reaction system. Said inert gas may include nitrogen gas, and rare-gas which belong to the group 18 elements such as helium, neon, argon, krypton, xenon, or the like. Two or more kinds of said gas may be used together.

Said organic-inorganic hybrid prepolymer is prepared by a condensation reaction with the hydrolysis of a mixture containing said oligomer and said PDMS in the presence of said condensation catalyst in the reactor the atmosphere in which has been replaced by said inert gas. Since said oligomer is easily hydrolyzed with water compared with said PDMS, the alkoxy group of said oligomer changes to a highly reactive silanol group.

In other words, said hydrolyzed alkoxy group of said oligomer produces a silanol group, and a condensation reaction with dehydration between said silanol group of the resulting hydrolyzed oligomer and the silanol group at the end of said PDMS is carried out by heating in the presence of said inert gas. In the present invention, said metal and/or semimetal alkoxide is provided as an oligomer, the single condensation reaction of said metal and/or semimetal alkoxide will not accelerate, so that the condensation reaction between the PDMS and the hydrolyzed oligomer can be smoothly carried out, to advance the condensation reaction favorably through the homogeneous reaction between said oligomer and said PDMS.

After all, since the unnecessary hydrolysis reaction from the water existing in the air is suppressed by the hydrolysis reaction and the condensation reaction under the inert gas atmosphere, the condensation reaction between the silanol group of said PDMS, which is an organic component, and the plural number of alkoxy groups of said oligomer, which is an inorganic component, is promoted, to produce smoothly an organic-inorganic hybrid prepolymer as a sol. Further the alcohol and/or water produced during said condensation reaction is removed from the reaction system by supplying said inert gas at a constant rate, so that said condensation reaction can be promoted. As a result, the production of clusters, which are homo-condensates of inorganic components, is prevented.

Further, a low molecular weight siloxane in said prepolymer, which causes deterioration of the organic-inorganic hybrid material, will be taken into the organic-inorganic hybrid prepolymer, or will volatilize during condensation reaction by heating, as a result, the amount of said low molecular weight siloxane existing in said prepolymer as a simple substance will become extremely small, or no low molecular weight siloxane as a simple substance will exist in said prepolymer.

As aforementioned, since no cluster which is an inorganic component, exists in said organic-inorganic hybrid prepolymer sol, or said organic-inorganic hybrid polymer produced by the gelation of said prepolymer sol, and so, by using said organic-inorganic hybrid composite, heat-resistant adhesive materials and heat conductive materials having a higher quality than conventional ones, can be provided.

### EXAMPLES

The present invention is further concretely explained by the following EXAMPLES.

Wherein “part”, “%” in EXAMPLES are respectively expressed in mass standard, “part by mass”, “% by mass”, unless a special description is added. Further, the preparation methods in which the rate of denaturing can be controlled are not limited by the methods described in EXAMPLES. For an evaluation of the rate of denaturing in EXAMPLES, the molecular weight measurement using SHODEX GPC-101 (Showadenko K.K.) is employed. The columns used in said molecular weight measurement are K-806M, and K-802.5 (SHODEX), which are connected.

Further, the present invention should not be limited by the EXAMPLES described hereafter.

### Example 1

### Preparation of Organic-Inorganic Prepolymer Sol

[Equipment, chemicals etc. used in Example 1]

The reactor used in EXAMPLE 1 was a flask having plural number of necks with a stirring device, a thermometer, and a dripping device are being fitted to said flask.

Heater: A heating mantle was used as a heater.

Nitrogen gas: Nitrogen gas was prepared by using nitrogen gas preparing equipment (JAPAN UNIX Co., Ltd. UNX-200)

Tetraethoxy silane oligomer (TEOS oligomer): Silicate 40 (n=4 to 6) or Silicate 45 (n=6 to 8) (Tama Chemicals Co., Ltd.) were used.

PDMS having silanol groups at both ends (Weight average molecular weight: 32,000) (Momentive Performance Materials Inc. XF 3905) was used.

### (Method for Preparation)

1) The air in the reactor was sufficiently replaced by nitrogen gas, after which, a TEOS oligomer and PDMS having silanol groups at both ends, were put into said reactor.

The amounts of said TEOS oligomer and said PDMS were the equivalent of 1 mol. each.

2) After step 1, nitrogen gas was put into the reactor, and further a t-butanol as a stabilizer was properly added to the reactor and the contents of said reactor were then stirred and mixed at room temperature for 30 minutes, after which the contents of said reactor were heated at a temperature of between 120 and 160° C., preventing the gas, with the exception of nitrogen gas, from invading the reactor, and then dibutyltin dilaurate as a catalyst was suitably added to said contents, and said contents were continuously stirred, to obtain the raw materials of solution A, in which said TEOS oligomer and said PDMS were mixed together.

3) The necessary amount of 0.93 g of water was dripped into the resulting raw material solution A prepared in step 2 for about one hour, and then the resulting mixture was further stirred and mixed.

4) After dripping said water in step 3, the mixture in the reactor was then heated to 140° C., and the condensation reaction with the hydrolysis of said TEOS oligomer and said PDMS was carried out for 10 hours.

5) After the reaction in step 4, the contents of said reactor were then cooled to below 50° C. by allowing them to stand, and further 3 parts by mass of t-butanol for said raw materials solution A was dripped as a stabilizing agent, and then the resulting mixture was stirred and mixed for 30 minutes, to prepare an organic-inorganic hybrid prepolymer sol by introducing said TEOS oligomer to both ends of said PDMS.

The rate of denaturing of said prepolymer (introduction rate of said oligomer to said PDMS) was estimated as 70%.

### (Setting of the Parameters)

In the aforementioned method for the preparation, the following parameters were set.
(A) The humidity of the nitrogen gas sent into the reactor: 98%
(B) The rate of delivery of the nitrogen gas: 200 cc/min.
(C) The combined amount of TEOS oligomer an amount corresponding to 2 mol
(D) The molecular weight of said silanol group modified PDMS 32,000
(E) The kind of stabilizing solvent: t-butanol
(F) The amount of stabilizing solvent: 5% (3 parts by mass)
(G) The reaction temperature: 140° C.
(H) The reaction time: 10 hours
(I) The kind of the catalyst: dibutyltin dilawrate
(J) The amount of catalyst: 045 ml

### (Forming of the Sheet)

Said organic-inorganic prepolymer sol solution prepared by the aforementioned method was then poured into a mold (15 square cm), the surface of which was treated with tetrafluoroethylene perfluoroalkylvinylether copolymer (PFA), so that the thickness of the sheet of the resulting organic-inorganic hybrid polymer was set to be 1 mm, after which said prepolymer sol solution in the mold was then heated at 120° C. for one hour, after which the temperature was raised to 200° C. for one hour, and then kept at 200° C. for two more hours.

Said prepolymer sol was hardened (gelated), to produce an organic-inorganic polymer by said heating treatment.

After that, the resulting sheet of said organic-inorganic polymer was then removed from the mold, to prepare the sheet 1 for evaluation (its length being 150 mm×width 150 mm×thickness 1 mm) as the sample for EXAMPLE 1.

### [Comparison 1]

### [Preparation of the Organic-Inorganic Hybrid Prepolymer Sol]

(Equipment, chemicals etc. used in Comparison 1)

Reactor: The same reactor as used in EXAMPLE 1 was used.

Heater: A heating mantle was used.

TEOS oligomer The same oligomer as used in EXAMPLE 1, was used.

PDMS having silanol groups at both ends: the same PDMS as used in EXAMPLE 1, was used.

### (Method for Preparation)

An organic-inorganic prepolymer was prepared by the method, following the conventional method described as follows.
1) One gram of TEOS oligomer and 32.0 gs of PDMS having silanol groups at both ends were put into a reactor which contained no nitrogen gas.
2) After step 1, the contents of the reactor were stirred and mixed at room temperature for about 30 minutes, to prepare a raw material solution A which was a mixture of said TEOS oligomer and said PDMS having silanol groups at both ends.
3) The necessary amount of 0.93 g of water was dripped into the resulting raw material solution A prepared in step 2 for about one hour, and then the resulting mixture was further stirred and mixed.
4) After the water was dripped into said raw material solution A in step 3, the contents of said reactor were heated to 140° C., after which the condensation reaction with the hydrolysis of said TEOS oligomer and said PDMS was carried out for 10 hours.
5) After the reaction in step 4, the contents of said reactor were naturally cooled to room temperature for 30 minutes, to introduce said TEOS oligomers to both ends of said PDMS and obtain an organic-inorganic hybrid prepolymer sol.

### [Forming of the Sheet]

The resulting organic-inorganic hybrid prepolymer sol solution was then poured into a mold (15 square cm), the surface of which was treated with tetrafluoroethylene perfluoroalkylvinylether copolymer (PEA), so that the thickness of the resulting organic-inorganic hybrid polymer was set to be 1 mm, after which said prepolymer sol solution in the mold was hated at 120° C. for one hour, after which the temperature was raised to 200° C. for one hour, and then kept at 200° C. for 2 hours.

Said prepolymer sol was then hardened (gelated), to produce an organic-inorganic polymer by said heat treatment.

After that, the resulting sheet of said organic-inorganic hybrid polymer was then removed from the mold to prepare sheet 1 for the evaluation (length 150 mm width 150 mm thickness 1 mm) as the sample for COMPARISON 1.

### (Preparation of the Sheet)

Using the resulting organic-inorganic hybrid prepolymer sol solution, a sheet 1 for COMPARISON 1 (length 150 mm width 150 mm thickness 1 mm) was obtained by the same method as employed in EXAMPLE 1.

### [Method for Evaluation]

### (Evaluation of the Surface Property)

Nanoclusters were determined by using an atomic force microscope (TM Microscopes, Auto-probe CP-R). As the cantilever used in said nanocluster determination, Si tip (Nano-Sensors NCH-10T type, length 129 μm, width 28 μm, thickness 3.8 μm, spring constant 31N/m, and the resonance frequency 312 kHz) was used, and nano-clusters were determined in the atmosphere. The size of the area of determination was set to be 10 square μm, and clusters were determined in 5 determination areas, and a number of cluster grains being more than 0.5 μm size, were determined.

### (Evaluations of the Amount of Volatile Components)

A determination of the volatile components in each sample was carried out by using evaluation equipment so as to determine the residual quantities of low molecular siloxane (including cyclic siloxane) which are the volatile components contained in PDMS. Said evaluation equipment used for the determination of low molecular siloxane was a Gas Chromatography Mass Spectrometry (hereafter abbreviated as GC-MS) to which a Cooled Injection System (hereafter abbreviated as CIS) (GERSTEL GmbH & Co., KG) equipped with a Twister Desorption Unit (hereafter abbreviated as TDU) was attached. Said GC-MS equipment was a 5975 B system, made by Agilent Technologies Inc. Samples having a prescribed weight were collected from the sheet for evaluation and sheet 1, after which these samples were each put into the sample holders, and said samples from the sheet for evaluation and sheet 1 in the sample holders were then respectively heated by pouring helium gas into said sample holders with the TDU. After heating, the resulting exhaust gas evaporating in the helium gas was absorbed into the absorption tube of the CIS unit, and then said exhaust gas absorbed into said absorption tube was poured into the GC-MS equipment so as to determine the kind and amounts of volatile components. The columns of said GC-MS equipment were capillary columns (liquid phase: phenylmethylsiloxane). The specifications of said GC-MS equipment were as follows. The temperature of the pouring opening: −150° C. to 12° C./sec to 32.5° C. the column: Agilent 19091S-433 (the length of the column being 60 m, the inside diameter 0.25 mm, and the thickness of the column membrane, 0.25 μm), the oven: 40° C.-25° C./min-300° C. (hold time: 10 minutes), the flow rate of helium gas: 1.2 ml/min, the temperature of the MS ion source: 230° C., the temperature of the MS quadrupole: 150° C., the MS ionization voltage: 69.9 eV, the scanning range: m/z 100 to 1000. Herein, MS is an abbreviation for the Mass Spectrometry.

Further, the volatile amount “0.00E+00” means 0.00 100, namely “3.50E+0.8” means 3.50 108.

### [Mechanical Strength Evaluation]

A general-purpose autograph (Shimadzu Corp. EZ-S) was used to determine the mechanical strength. In order to evaluate the mechanical strength, the breaking strength (strength at rupture) of the sheet samples, which is the most important factor for the practical usage, were determined, comparing the evaluation sheet (comparison sheet sample), and sheet 1 (sheet sample of EXAMPLE 1).

### (Heat-Resisting Property Evaluation)

For the heat-resistance test, the rate of weight change was determined. Namely, each sample was put into a means of heating, and then heated, the temperature changing step by step from 200° C.-210° C.-220° C. . . . and after 100 hours from the start of said heating, the rate of the weight change from the original weight was determined. As said means of heating, a convection drying furnace was used.

### [The Results of Evaluations of the Samples of Example 1 and Comparison 1]

The results of evaluations of the samples of EXAMPLE 1 and COMPARISON 1 are shown in Table 1. Referring to Table 1, comparing the sheet sample of EXAMPLE 1, which was gelated organic-inorganic hybrid prepolymer sol (the burned and hardened substance) of EXAMPLE 1, and the comparison sheet sample, which was gelated organic-inorganic hybrid prepolymer sol (the burned and hardened substance) of COMPARISON 1, it is recognized that 20 clusters were observed in the comparison sheet sample, while no clusters were observed in the sheet sample of EXAMPLE 1.

Accordingly, it is recognized that said gelated organic-inorganic hybrid prepolymer sol (the burned and hardened substance) of the present invention has more ideal properties in the four items evaluated than said gelated organic-inorganic hybrid prepolymer sol (the burned and hardened substance) of the COMPARISON, which was prepared in a reactor containing no nitrogen gas.

TABLE 1

| | | Sheet sample of | Sheet sample of |
|---|---|---|---|
| Evaluation item | Unit | COMPARISON 1 | EXAMPLE 1 |
| Number of clusters | Number | 20 | 0 |
| Amount of volatile | Ct | None detected | None detected |
| components produced | | | |
| Breaking strength | MPa | 1.4 | 2.5 |
| Rate of weight | % | 4.5 | 1.5 |
| reduction by heating | | | |

Herein the rate of denaturing was obtained by the mass rate between the TEOS oligomer, and the PDMS having silanol groups at both ends, which react together. Any method can be employed to determine the mass rate. The method employed in EXAMPLES was the method using a GPC (Gel Permeation Chromatography System).

The evaluation methods in EXAMPLES were the conventional methods having been used for the evaluations of many properties of synthetic polymers. In EXAMPLES, the molecular weight distribution of said synthesized organic-inorganic prepolymer sol was determined by said method, and the ratio of peaks between the TEOS oligomer and the PDMS having silanol groups at both ends is regarded as the rate of denaturing.

Further, the volatile amounts are represented as the peak areas, and units in counts (abbreviation “ct”).

Further, “the Breaking Strength” shown in Table 1 was determined by the flexural property test method according to the ISO (International Standard Organization), ISO 178, and the units in Mpa [Megapascal] (1 Mpa=10.1972 kgf/cm²).

### Example 2

### Preparation of the Organic-Inorganic Hybrid Prepolymer Sol

Using the same reactor as used in Example 1, an organic-inorganic prepolymer sol was prepared by controlling the rate of denaturing. In this EXAMPLE, parameters were set in the following values, and the same reactions in EXAMPLE 1 were applied.
(A) The humidity of the nitrogen gas sent into the reactor: 98%
(B) The rate of delivery of the nitrogen gas: 300 cc/min.
(C) The combined amount of TEOS oligomer an amount corresponding to 2 mol.
(D) The molecular weight of said PDMS, having silanol groups at both ends: 32,000
(E) The kind of stabilizing solvent: t-butanol
(F) The amount of stabilizing solvent: 5%
(G) The reaction temperature: 120° C.
(H) The reaction time: 4 hours
(I) The kind of catalyst: dibutyltin dilaurate
(J) The amount of catalyst: 0.15 ml

### [Forming of the Sheet]

Forty parts by mass of mica filler (YAMAGUCHI MICA CO., LTD. SJ-005) was uniformly mixed into the resulting organic-inorganic hybrid prepolymer prepared in this EXAMPLE by using a stirrer, to obtain a mixture.

The resulting organic-inorganic hybrid prepolymer sol mixture was then poured into a mold (15 square cm), the surface of which was treated with PFA, so that the thickness of the sheet of the resulting organic-inorganic hybrid polymer was set to be 1 mm, after which said prepolymer sol mixture solution in the mold was heated at 130° C. for one hour, after which the temperature was raised to 220° C. for one hour, and then kept at 220° C. for four hours for the drying and burning treatment, so as to harden (gelate) said mixture. After that, the resulting sheet of said organic-inorganic polymer was then removed from the mold so as to prepare sheet 2 for evaluations (length 150 mm width 150 mm thickness 1 mm) as the sample for EXAMPLE 2.

### [Comparison 2]

### [Preparation of the Organic-Inorganic Hybrid Prepolymer Sol.]

An organic-inorganic hybrid prepolymer sol for COMPARISON 2 was prepared with the same equipment, same chemicals, and same method as applied in COMPARISON 1.

### [Forming of the Sheet]

Forty parts by mass of mica filler (YAMAGUCHI MICA CO., LTD. SJ-005) was uniformly mixed into the resulting organic-inorganic hybrid prepolymer sol for COMPARISON 2 with a stirrer, to obtain a mixture. The resulting mixture was then hardened by the same method as applied in EXAMPLE 2. After that, the resulting sheet was then removed from the mold so as to prepare the sheet as the sample for COMPARISON 2 (length 150 mm width 150 mm thickness 1 mm).

### [Method for Evaluations]

Using the same apparatus for the evaluations as used in EXAMPLE 1 and COMPARISON 1, 4 items of evaluations, a surface property evaluation (number of cluster grains), a volatile component evaluation, a mechanical strength evaluation, and a heat resistance evaluation were made.

### [The Results of the Evaluations of Example 2 and Comparison 2]

The results of the evaluations of EXAMPLE 2 and COMAPRISON 2 are shown in Table 2. Referring to Table 2, it is recognized that comparing the sheet of EXAMPLE 2 produced from the hardened (gelated) substance of the mixture of said organic-inorganic hybrid prepolymer sol of the present invention, mica being mixed into said prepolymer, and the sheet of COMPARISON 2, produced from the hardened (gelated) substance of said organic-inorganic hybrid prepolymer prepared by the method in which no nitrogen gas was delivered into the reactor, 25 numbers of clusters were observed in said sheet of COMPARISON 2, while no clusters were observed in said sheet of EXAMPLE 2.

In conclusion, it is recognized that sheet of the hardened (gelated) organic-inorganic hybrid prepolymer sol of the present invention has more ideal properties than the sheet of hardened (gelated) organic-inorganic hybrid prepolymer sol of COMPARISON 2 in the four items evaluated.

TABLE 2

| | | Sheet sample of | Sheet sample of |
|---|---|---|---|
| Evaluation item | Unit | COMPARISON 2 | EXAMPLE 2 |
| Number of clusters | Number | 25 | 0 |
| Amount of volatile | Ct | None detected | None detected |
| components produced | | | |
| Breaking strength | MPa | 4.5 | 6.8 |
| Rate of weight | % | 3.5 | 1.7 |
| reduction by heating | | | |

The units shown in Table 2 are the same as the units shown in Table 1.

The aforementioned EXAMPLES are illustrations to explain the present invention, and the present invention should not be limited only by said EXAMPLES, and alterations, deletions and additions may be possible if said alterations, deletions and additions are not contradictory to the technical idea of the present invention, which can be recognized by a person skilled in the art.

Said aforementioned EXAMPLES should not limit the scope of the present invention, and different kinds of metal and/or semimetal alkoxide having different properties may also be used in the present invention. In the aforementioned EXAMPLES, since said organic-inorganic prepolymer compound is in sol state, in order to obtain a solid or semisolid state molded article of said organic-inorganic compound, said sol state organic-inorganic prepolymer should be coated onto a tray such as a mold and then dried and burned to harden (gelate). The shape of the resulting molded article is not especially limited, but commonly may be sheet or panel-like.

It is preferable that the combination rate of said metal and/or semimetal alkoxide oligomer (A), and said silanol modified PDMS (B) is set to be in the range of between 0.1 and 1.0 as a mol ratio (A/B). The optimum rate of combination is about 1 mol ratio (A/B), said optimum rate of combination 1 mol ratio (A/B) being the basis of softness and hardness, so that in a case where softness (low hardness) of the resulting polymer is required, the rate of said PDMS (B) will preferably be increased, and in a case where hardness (high hardness) is required, the rate of said metal and/or semimetal alkoxide oligomer (A) will preferably be increased.

The degree of the polymerization of said oligomer (A) is preferably in the range of between 4 and 16. In a case where the degree of polymerization is below 4, the effect of the properties of said oligomer (A) will decrease, while in a case where the degree of polymerization is beyond 16, the viscosity of said oligomer (A) will increase, and said oligomer having a high viscosity will be hard to deal with when said prepolymer is synthesized.

Further, the purity of said inert gas used for replacement may be higher than 80%, and the water content of said inert gas may be below 20%.

The ceramic filler may be combined with said organic-inorganic hybrid compound of the present invention so as to provide the heat conductivity in a case where said organic-inorganic hybrid compound is applied to a heat resistant elastic material, and a scaly insulating filler may be combined with said organic-inorganic hybrid compound to create an insulating property. On the other hand, in the case of optical use, wherein transparency is needed, said prepolymer sol may be hardened without being combined with said filler. In a case where said prepolymer is used as an adhesive, said prepolymer may be provided in a semihardened state so as to be hardened by heating when it is used.

Using the synthesizing method of the present invention, a proper rate of denaturing for many types of usage may be easily set, so that said hybrid prepolymer sol of the present invention can be provided for various types of usage desired. Said usages may be such as a sealant, adhesive, heat conductive sheet, isolation sheet, interlayer isolation membrane, or the like.

As the application technology of said organic-inorganic hybrid prepolymer of the present invention, said prepolymer can be used as an adhesive and a paint.

The hardened (gelated) organic-inorganic prepolymer of the present invention has a property that makes said prepolymer preferable for its elasticity at a high temperature, and has the ability to relax the thermal expansion of the materials to be adhered to, by the shock of coldness and hotness. Accordingly, said prepolymer of the present invention can be used as an adhesive layer to relax thermal stress by said prepolymer intermediating between the materials to be adhered, said materials being of different qualities to each other.

Further, as the application technology of said organic-inorganic hybrid compound of the present invention, said prepolymer can be used as a sealant and a potting material used in the semiconductive element such as a luminescence element like a laser diode, or the like, a light receiving element like an image sensor, or the like.

### POSSIBILITY OF THE INDUSTRIAL USE

According to the present invention, since the resulting organic-inorganic hybrid material contains no clusters causing any deteriorations of the mechanical strength, of the gas barrier properties and of the optical properties, the present invention can be applied industrially.

1. An organic-inorganic hybrid prepolymer which is prepared by introducing a metal and/or semimetal alkoxide oligomer to one or both ends of a polydimethylsiloxane having silanol group(s) on one or both ends by a condensation reaction accompanied with hydrolysis, and adding tertiary butanol as a stabilizing solvent.

2. An organic-inorganic hybrid prepolymer in accordance with claim 1, wherein said polydimethylsiloxane having silanol group(s) on one or both ends has a weight-average molecular weight in the range of between 1,500 and 100,000, and said metal and/or semimetal alkoxide oligomer has a degree of polymerization in the range of between 4 and 16.

3. An organic-inorganic hybrid prepolymer in accordance with claim 1, wherein said metal and/or semimetal alkoxide is a silane alkoxide.

4. A method for preparing an organic-inorganic hybrid prepolymer by substituting an inert gas atmosphere in a reactor, filling said reactor with a solution of a polydimethylsiloxane having silanol group(s) on one or both ends, adding a metal and/or semimetal alkoxide to said solution in said reactor, performing a hydrolysis and condensation reaction, to introduce said metal and/or semimetal alkoxide to one or both ends of said polydimethylsiloxane, and adding tertiary butanol as a stabilizing solvent.

5. An organic-inorganic hybrid prepolymer in accordance with claim 4 wherein said polydimethylsiloxane having silanol group(s) on one or both ends has a weight-average molecular weight in the range of between 3000 and 100,000, and said metal and/or semimetal alkoxide oligomer has a degree of polymerization in the range of between 4 and 16.

6. An organic-inorganic hybrid prepolymer in accordance with claim 4, wherein said metal and/or semimetal alkoxide is a silane alkoxide.

7. An organic-inorganic hybrid prepolymer in accordance with claim 2, wherein said metal and/or semimetal alkoxide is a silane alkoxide.

8. An organic-inorganic hybrid prepolymer in accordance with claim 5, wherein said metal and/or semimetal alkoxide is a silane alkoxide.
